(19) United States
(12) Patent Application Publication
(10) Pub. No.: US 2023/0127032 A1
(43) Pub. Date: Apr. 27, 2023

(54) INTERNAL PRESSURE CONTROL AND COLLECTION OF SCATTERED DEVELOPER IN DEVELOPING DEVICE

(71) Applicant: HEWLETT-PACKARD DEVELOPMENT COMPANY, L.P., Spring, TX (US)

(72) Inventors: Tadao MORI, Yokohama (JP); Naoya IWATA, Yokohama (JP); Takayuki YAMADA, Yokohama (JP)

(21) Appl. No.: 17/911,734

(22) PCT Filed: Feb. 11, 2021
(86) PCT No.: PCT/US2021/017547

§ 371 Date: Sep. 15, 2022

(30) Foreign Application Priority Data
Mar. 27, 2020 (JP) 2020-057339

(51) Int. Cl. G03G 15/09; G03G 15/08

(52) U.S. Cl. CPC G03G 15/0921; G03G 15/0808

(57) ABSTRACT

A developing device includes a developer roller that is rotatable about an axis, to carry a developer to a development region; a rectifier member extending in a direction parallel to an axial direction of the developer roller. The rectifier member includes a developer collecting part that is spaced apart by a predetermined distance from a surface of the developer roller, and a rectifying part to guide air from within the developing device via the developer collecting part toward an upstream side of the development region, in a rotational direction of the developer roller.

### BACKGROUND

Some developing devices in image forming apparatuses such as printers and multifunctional devices, are provided with a developer roller, a layer regulating member, a stirring and conveying member, a developer container and the like, and use a two-component developer including toner and carrier. When such a developing device is operated, the developer accommodated in the developer container is magnetically adsorbed onto the rotating developer roller after having been stirred and conveyed by a stirring and conveying member, and then formed into a thin layer of developer by a layer regulating member; and the toner is adsorbed from the thin layer of developer on the developer roller onto an electrostatic latent image on a rotating photoconductor to develop the electrostatic latent image.

### BRIEF DESCRIPTION OF FIGURES

FIG. 1 is a schematic view of an example image forming apparatus including an example developing device.

FIG. 2 is a perspective view of the example developing device.

FIG. 3 is a cross-sectional view of the example developing device, schematically showing air guide member of the developing device.

FIG. 4 is a perspective view illustrating a part of the example developing device of FIG. 3 including an example upper cover, and an example rectifier member disposed on the upper cover.

FIG. 5 is a perspective view of the example rectifier member illustrated in FIG. 4.

FIG. 6 is an enlarged cross-sectional view showing a vicinity of the example rectifier member in the example developing device.

FIG. 7 is a schematic view showing an example air flow passage in the example developing device.

FIG. 8 is a graph an amount of remaining developer in the air flow passage in relation to a distance between a developer collecting part of the example rectifier member and a developer roller of the developing device.

FIG. 9 is an schematic view of a portion of the example developing device, showing a positional relation between an air intake part of the example rectifier member and a magnetic pole of the developer roller.

FIG. 10 is a schematic cross-sectional view showing another example developing device.

FIG. 11 is a schematic view showing an example air flow passage in another example developing device.

FIG. 12A is a partial cross-sectional view of an example developing device including an example separator member.

FIG. 12B is a partial cross-sectional view of an example developing device including another example separator member.

FIG. 12C is a partial cross-sectional view of an example developing device including another example separator member.

FIG. 12D is a partial cross-sectional view of an example developing device including another example separator member.

FIG. 12E is a partial cross-sectional view of an example developing device including another example separator member.

### DETAILED DESCRIPTION

In order to reduce cost and resources, some developing devices using a two-component developer adopt a developer supply and discharge technology or device which achieves longer service life by supplying and discharging the developer. Such developing devices are provided, for example, with a developer supply portion for supplying a new developer into a developer container and a developer discharging portion for discharging, to the outside of the developer container, a deteriorated developer that has become in excess due to the supply of the new developer.

During operation of such developing devices, air outside the developing device is taken therein through developer formed (e.g., magnetic formation of developer such as a magnetic brush) on a rotating developer roller.

Further, each functional member in the developing device, e.g., the developer roller, rotates at a higher speed due to an increased speed of printing performance of the image forming apparatus.

An example developing device includes a rectifier member extending in a direction parallel to an axial direction of a developer roller. The rectifier member may include a developer collecting part separated by a predetermined distance from a surface of the developer roller and a rectifying part to guide air from within the developing device to the developer collecting part toward an upstream region in a direction of rotation of the developer roller, for example toward an upstream side of a closest position (e.g., a development region) between the developer roller and a photoconductor, in the direction of rotation of the developer roller.

The air taken in the developing device from the outside during operation of the developing device is drawn close to the developer roller by the rectifier member to be guided to an air guide member. Scattered developer included in the air is collected by a magnetic adsorption force of the developer roller.

A positive pressure location (or positive pressure region) is located downstream of a closest position between the developer roller and a photoconductor in the direction of rotation of the developer roller, and a negative pressure location (or negative pressure region) is located upstream of the closest position between the developer roller and the photoconductor in the direction of rotation of the developer roller. During operation of the developing device, in the positive pressure location a higher pressure is formed relative to the negative pressure location, and in the negative pressure location a lower pressure is formed relative to the positive pressure location.

In some examples, the positive pressure location may be located within the developing device, for example at a position where air having passed through the closest position between the developer roller and the photoconductor flows into a developer container, and the negative pressure location may be located upstream and in the vicinity of the closest position (e.g., on the upstream side of the closest position) between the developer roller and the photoconductor in the direction of rotation of the developer roller.

In the following description, with reference to the drawings, the same reference numbers are assigned to the same components or to similar components having the same function, and overlapping description is omitted. The terms “left” and “right” signify respective directions when a drawing is viewed from the front, and they are not always in agreement with directions during actual use of a device. Scale reductions in the drawings are not always based on actual dimensions, and partial emphases are sometimes made for explanation of the operations and effects of the present disclosure.

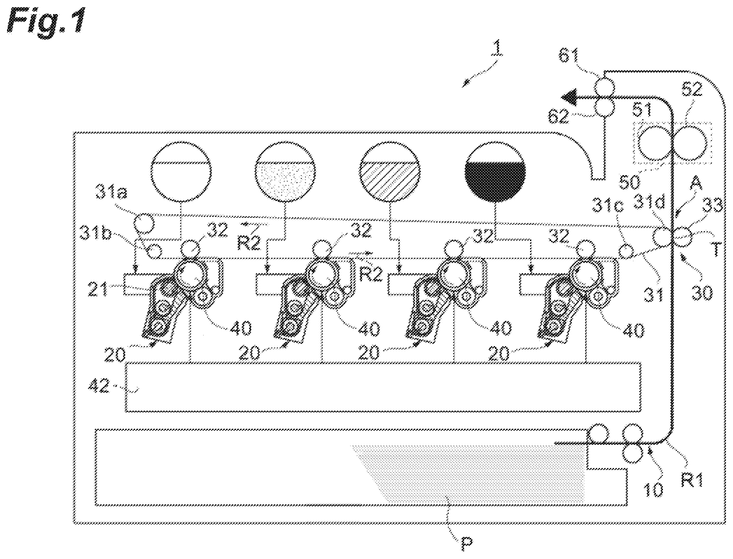

FIG. 1 shows an example image forming apparatus 1 in which the example developing device can be implemented. The image forming apparatus 1 forms color images by use of each color of magenta, yellow, cyan and black. The image forming apparatus 1 has a recording medium conveyance device 10 for conveying paper P as a transfer material, a developing device 20 for developing an electrostatic latent image, a transfer device 30 for transferring a toner image onto the paper P, a photoconductor 40 as an electrostatic latent image carrier, and a fixing device 50 for fixing the toner image onto the paper P. In the present description, the developing device 20 may refer to one or more developing devices 20, and the photoconductor 40 may refer to one or more photoconductors 40.

The recording medium conveyance device 10 conveys the paper P along a conveyance path R1. The recording medium conveyance device 10 conveys the paper P to arrive at a secondary transfer region A through the conveyance path R1 at a timing when a toner image to be transferred to the paper P arrives at the secondary transfer region A.

Four of the developing devices 20 are provided for the respective colors of magenta, yellow, cyan and black. Four of the photoconductors 40 are provided adjacent the respective four developing devices 20. Each developing device 20 includes a developer roller 21 to transfer toner to an adjacent one of the photoconductors 40. The developer roller 21 carries a developer that is formed by mixing and stirring toner and carrier. A rotation of the developer roller 21 conveys the developer to a region (e.g., a development region) facing the photoconductor 40, where the toner in the developer carried by the developer roller 21 is transferred to an electrostatic latent image formed on an outer circumferential surface of the photoconductor 40 to develop the electrostatic latent image.

The transfer device 30 conveys a toner image formed by each of the four developing devices 20 to the secondary transfer region A where the toner image is to be transferred to the paper P. The transfer device 30 includes an intermediate transfer belt 31 as an image carrier, suspension rollers 31a, 31b and 31c and a drive roller 31d suspending (or supporting) the intermediate transfer belt 31, a primary transfer roller 32 located adjacent one of the photoconductors 40 such that the intermediate transfer belt 31 extends between the primary transfer roller 32 and the photoconductor 40, and a secondary transfer roller 33 located adjacent the drive roller 31d such that the intermediate transfer belt 31 extends between the secondary transfer roller 33 and the drive roller 31d. The intermediate transfer belt 31 is an endless image carrier, which is circularly driven by rotation of the suspension rollers 31a, 31b and 31c, and the drive roller 31d. The intermediate transfer roller 31 moves on a moving path R2 by rotation of the drive roller 31d in the forward direction (that is, counterclockwise direction viewed in FIG. 1). In the present description, the primary transfer roller 32 may refer to one or more primary transfer rollers 32. For example, the image forming apparatus 1 includes four of the primary transfer roller 32 located adjacent the four photoconductors 40, respectively, in association with the four colors of magenta, yellow, cyan and black.

Each primary transfer roller 32 presses against the photoconductor 40 via an inner circumference of the intermediate transfer belt 31. The secondary transfer roller 33 presses against the drive roller 31d from an outer circumference of the intermediate transfer belt 31 during the transfer of the toner image formed on the intermediate transfer belt 31. The secondary transfer roller 33 contacts the intermediate transfer belt 31 adjacent the drive roller 31d, to follow the drive roller 31d in rotation. The secondary transfer roller 33 transfers the toner image formed on the intermediate transfer belt 31 to the paper P. A contact point between the intermediate transfer belt 31 and the secondary transfer roller 33 is a transfer portion T into which the paper P conveyed along the conveyance path R1 continuously enters at predetermined intervals. At this transfer portion T, the secondary transfer roller 33 continuously performs transferring onto the paper P.

The four photoconductors 40 are associated with the four colors of magenta, yellow, cyan and black, respectively. The photoconductors 40 are respectively arranged at four locations along the moving path R2 of the intermediate transfer belt 31. For each of the photoconductors 40, an adjacent one of the developing devices 20 and an exposure device 42 are arranged at a position facing the photoconductor 40.

The fixing device 50 allows the toner image secondarily transferred from the intermediate transfer belt 31 to the paper P, to adhere and be fixed to the paper P. The fixing device 50 is provided with a heating roller 51 for heating the paper P and a pressure roller 52 for pressing against the heating roller 51. The toner image is fused and fixed to the paper P by passing the paper P between the heating roller 51 and the pressure roller 52. The paper P having the fixed toner image passes between discharge rollers 61, 62 and is discharged to the outside of the image forming apparatus 1.

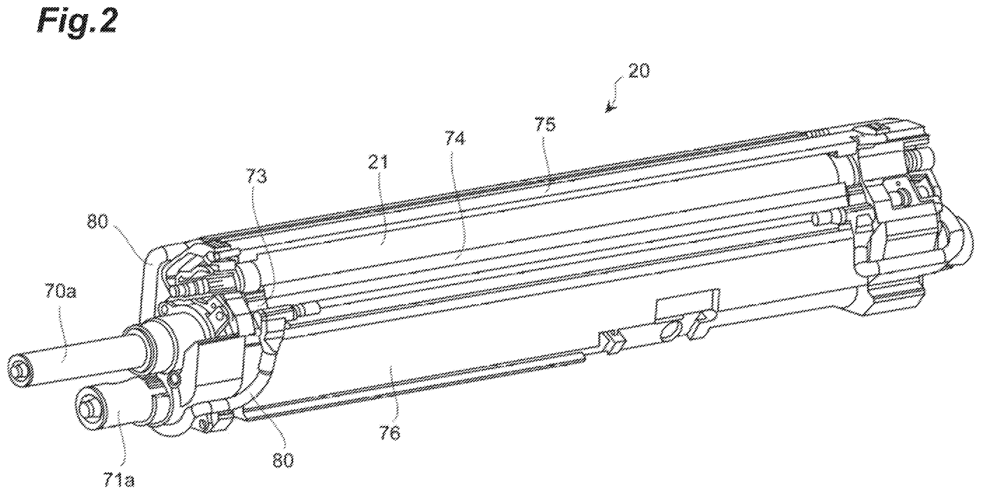

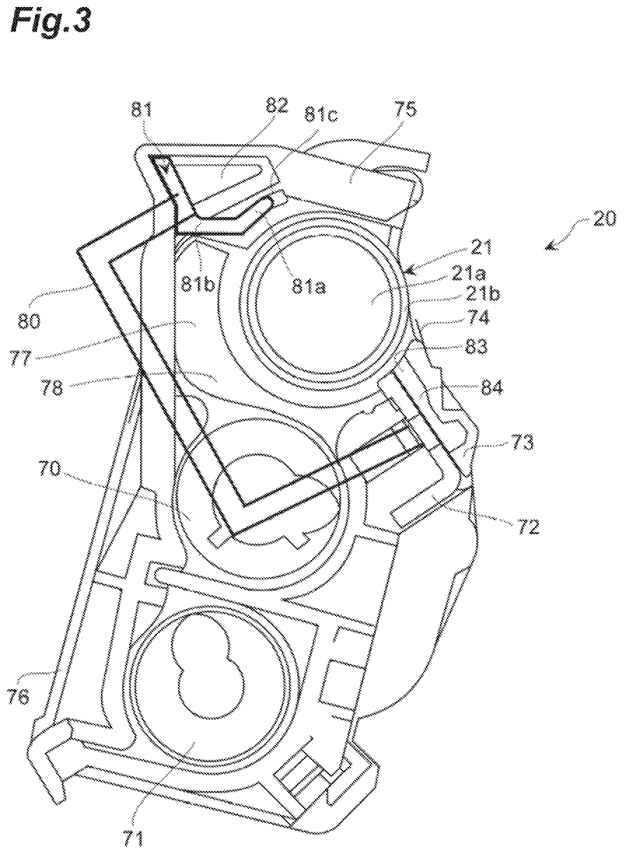

FIG. 2 is a perspective view of the example developing device 20, as viewed from the side of the photoconductor 40 (cf. FIG. 1). FIG. 3 is a cross-sectional view of the example developing device 20.

With reference to FIG. 2, the developing device 20 may include, for example, the developing roller 21, stirring and conveying members 70, 71 (cf. FIG. 3) for stirring and conveying a two-component developer including toner and carrier, covers 70a, 71a of the stirring and conveying members 70, 71, a layer regulating member 72 (cf. FIG. 3) for forming the developer into a thin layer of developer, a layer regulating member cover 73 for protecting the layer regulating member 72, a seal member 74 disposed in the layer regulating member cover 73 and in contact with the photoconductor 40 (cf. FIG. 1) to prevent the developer from entering the exposure device 42 (cf. FIG. 1) side of the developing device 20, located below the photoconductor 40, an upper cover 75 for protecting the upper side of the developer roller 21, a housing 76 for accommodating or supporting those constituent elements, and an air guide member 80 disposed outside the housing 76 for circulating air inside the developing device 20.

As shown in FIG. 3, both ends of the air guide member 80 are respectively fluidically connected to an inlet port 82 and an outlet port 83 disposed within the developing device 20. An air flow passage 84 is formed between the layer regulating member 72 and the layer regulating member cover 73, and the outlet port 83 is formed at the ends facing the developer roller 21 of the layer regulating member 72 and the layer regulating member cover 73. The housing 76 has a developer container 77 disposed therein for accommodating the developer. The upper cover 75 constitutes part of the developer container 77. The developer is accommodated within the developer container 77 and stirred and conveyed by the stirring and conveying members 70, 71 to be magnetically adsorbed onto the developer roller 21. The developer roller 21 is disposed to face the adjacent photoconductor 40 (cf. FIG. 1) so as to form a gap with the photoconductor 40. The developer roller 21 has a surface, and rotates while carrying, on the surface, the developer accommodated in the developer container 77. The developer roller 21 is provided with a developing sleeve 21b for forming a surface layer of the developer roller 21, and a magnetic roller 21a disposed inside the developing sleeve 21b. The developing sleeve 21b is a cylindrical member formed of a non-magnetic metal. The developing sleeve 21b is axially rotatable. The developing sleeve 21b is, for example, rotatably supported by the magnetic roller 21a, and is driven and rotated by a driving source such as a motor. The developer is carried on the surface of the developing sleeve 21b by a magnetic force of the magnetic roller 21a. The developer roller 21 conveys the developer in the direction of rotation of the developing sleeve 21b by the rotation of the developing sleeve 21b. The magnetic roller 21a is fixed to the developer container 77 and has a plurality of magnetic poles. That is, the magnetic roller 21a forms magnetic poles along the axial direction at predetermined angle positions. When the developing sleeve 21b passes through the locations corresponding to the respective magnetic poles (positions fixed with respect to the developing container 77) of the magnetic roller 21a, a magnetic force acts on the developer on the developing sleeve 21b. The developing device 20 is also provided with a rectifier member 81 attached to the upper cover 75.

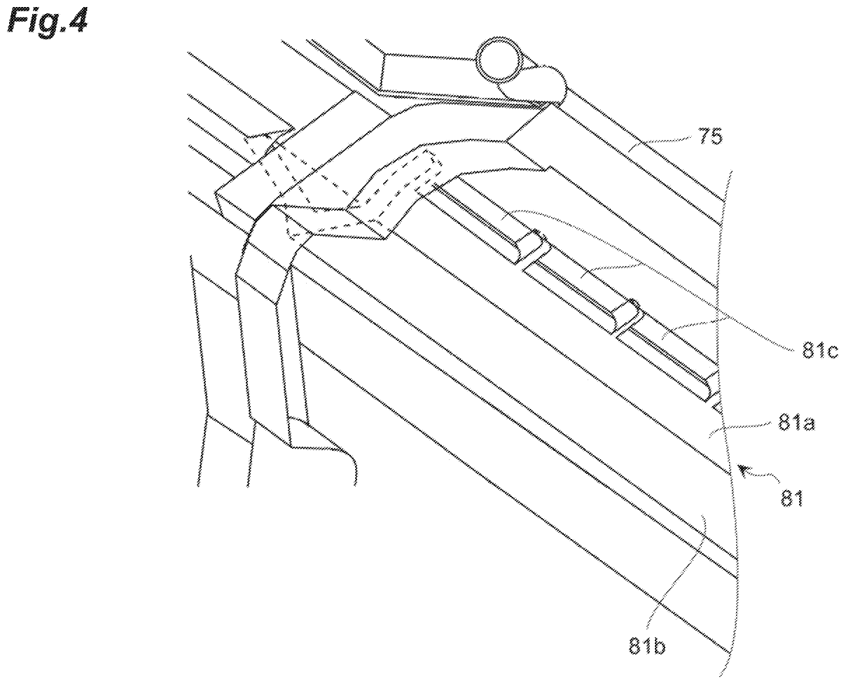

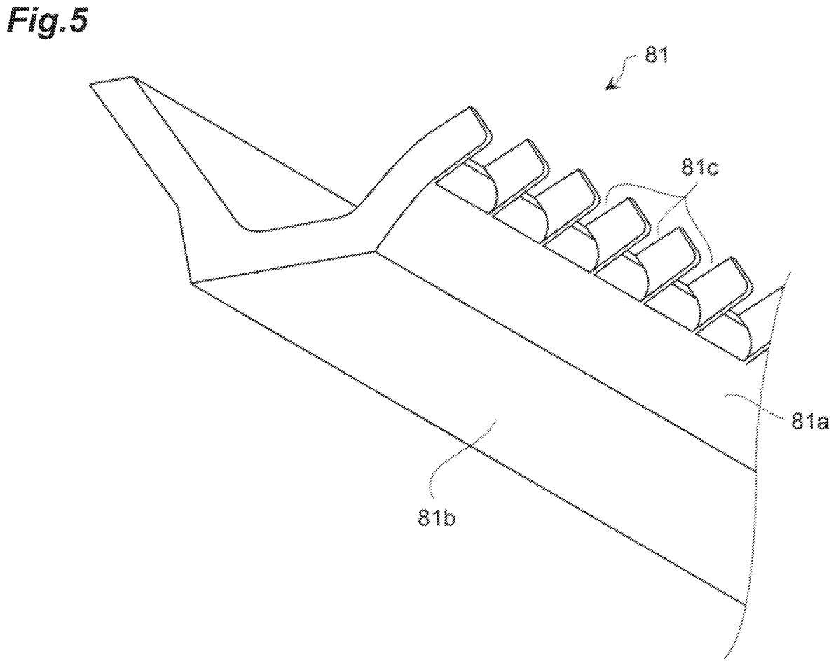

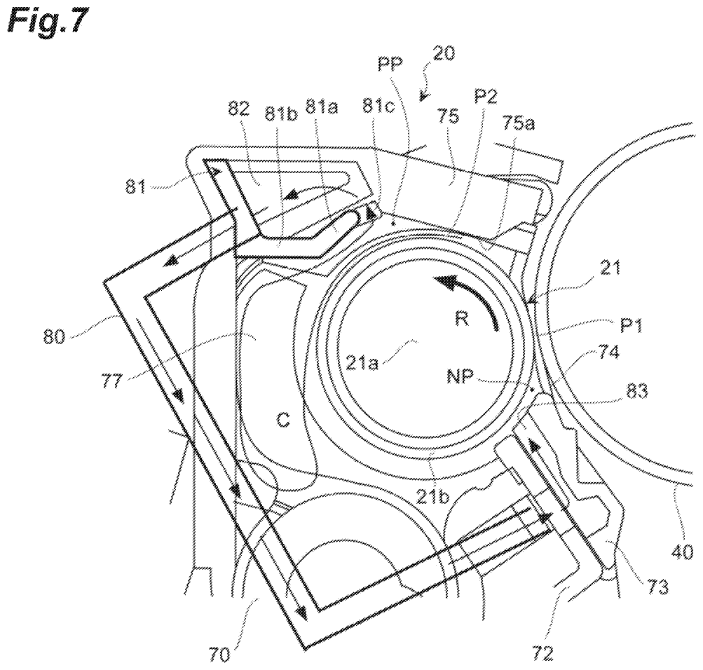

FIG. 4 is a partial perspective view of the example developing device 20 of FIG. 3, showing the vicinity of an end portion of the upper cover 75 to which the example rectifier member 81 is attached. FIG. 5 is a partial perspective view of the example rectifier member 81, showing the vicinity of an end portion of the example rectifier member 81. As will be described further below, the rectifier member 81 brings air located close to the developer roller 21 within the developing device 20, namely from within the developer container 77, toward the air guide member 80, so as to guide air along the surface of the developer roller 21 toward an upstream region in the direction of rotation, for example, toward a region located adjacent the developer roller 21 and on an upstream side of a closest position P1 (cf. FIG. 7) between the developer roller 21 and the photoconductor 40, in the direction of rotation of the developer roller 21.

With reference to FIG. 3 to FIG. 5, the rectifier member 81 extends in a longitudinal direction parallel to the axial direction of the developer roller 21 while facing the developer roller 21. The rectifier member 81 has a developer collecting part 81a separated by a predetermined distance from the surface of the developer roller 21. As will be described below, the rectifier member 81 has a rectifying part 81b to rectify air that has entered the developing device 20. The rectifier member 81 also has an air intake part 81c disposed upstream of the developer collecting part 81a in the direction of rotation of the developer roller 21. The rectifier member 81 may, for example, be formed of a material such as engineering plastic.

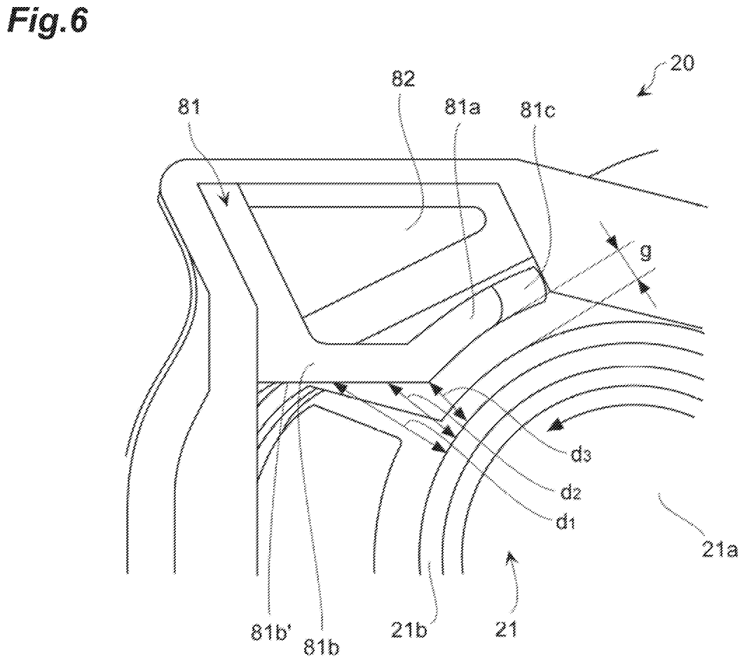

FIG. 6 is an partial and enlarged cross-sectional view of the example developing device 20, showing the example rectifier member 81 disposed within the developing device 20. As is shown in the figure, the rectifying par 81b of the rectifier member 81 is formed, for example, such that the minimum distance between the surface 81b′ of the rectifying part 81b facing the developer roller 21 and the surface of the developer roller 21 (for example, distances d1 to d3 along the normal direction of the surface of the developer roller 21) gradually decreases from a remote location (or distal location) to a proximal location on the surface 81b′ relative to the developer collecting part 81a. Accordingly, the distance between the surface of the developer roller 21 and the rectifying part 81b gradually increases along the direction of rotation of the developer roller 21. The surface of the developer collecting part 81a facing the developer roller 21 may have a substantially uniform or constant distance from the surface of the developer roller 21 along a peripheral direction of the developer roller 21, such that the surface of the developer collecting part 81a and the facing surface of the developer roller 21 form a similar shape. For example, the surface of the developer collecting part 81a may follow a curvature of the facing surface of the developer roller 21.

FIG. 7 is a cross-sectional view showing the example developing device 20 together with the photoconductor 40, in which the example air flow passage is indicated by thin arrows. During operation of the developing device 20, the developer roller 21 (namely, the developing sleeve 21b) rotates in the direction of the arrow R shown in FIG. 7. Consequently, the air outside the developing device 20 enters the developer container 77 through the developer magnetically adsorbed onto the developer roller 21, that forms a magnetic brush formation on the developer roller 21. Consequently, a positive pressure is generated inside the developer container 77, namely at a positive pressure location (or positive pressure region) PP, while a negative pressure is generated on an upstream side of (e.g., upstream of and in the vicinity of) the closest position P1 between the developer roller 21 and the photoconductor 40, in the direction of rotation of the developer roller 21, namely at a negative pressure location (or negative pressure region) NP.

According to examples, the inlet port 82 is located at the positive pressure location PP within the developing device 20 and the outlet port 83 is located at the negative pressure location NP within the developing device 20. The inlet port 82 may be located within the developer container 77 at a position where air having passed beyond the closest position P1 between the developer roller 21 and the photoconductor 40, flows into the developer container 77. The difference in the pressure between the inlet port 82 and the outlet port 83 generates an air flow from the inlet port 82 to the outlet port 83 within the air guide member 80. The air discharged from the outlet port 83 after passing through the air guide member 80 flows toward the developer roller 21 facing the outlet port 83, and scattered developer included in the discharged air (referred to hereinafter as “scattered developer”) is collected by the developer on the developer roller 21. The air from which the scattered developer has been collected then passes between the developer roller 21 and the photoconductor 40 to flow to the positive pressure location PP, and subsequently flows through the inlet port 82 to the outlet port 83 within the developing device 20 in a similar manner as described above. Accordingly, the air is circulated along a route in the order of the positive pressure location PP, the inlet port 82, the air guide member 80, the outlet port 83, the negative pressure location NP, and the positive pressure location PP, to prevent or inhibit an increase in the atmospheric pressure within the developing device 20.

Here, the air flow within the developing device 20 will be described. As is indicated by the thin arrows C, the air entering the inside of the developing device 20 is first delivered downward (e.g., downstream) by the developer on the developer roller 21 (that is, the magnetic brush) along the direction of rotation of the developer roller 21 and flows to a region where the developer is stirred and conveyed by the stirring and conveying member 70. Thereafter, the air changes direction upward and then flows upward along an inner wall of the developer container 77, and is rectified by the rectifying part 81b of the rectifier member 81 and flows to the developer collecting part 81a of the rectifier member 81. As the rectifying part 81b has a shape as shown in FIG. 6, it guides the air that has moved upward along the inner wall of the developer container 77 and reached the rectifying part 81b to a region between the developer collecting part 81a and the developer roller 21.

When the air is guided between the developer collecting part 81a and the developer roller 21 by the rectifying part 81b, scattered developer that is carried in the air, is collected by the magnetic adsorption force of the developer roller 21. Then, the air from which the scattered developer has been removed flows to the inlet port 82 through the air intake part 81c. As is described below, this occurs because a gap at a closest position P2 between an inner surface 75a of the upper cover 75 and the surface of the developer roller 21, located upstream of the air intake part 81c in the direction of rotation of the developer roller 21, is sealed by the developer carried on the developer roller 21, namely by the magnetic formation of developer (e.g., magnetic brush) formed on the developer roller, and consequently, the air advanced from the rectifying part 81b of the rectifier member 81 to the developer collecting part 81a is restricted to a route through the air intake part 81c and the inlet port 82.

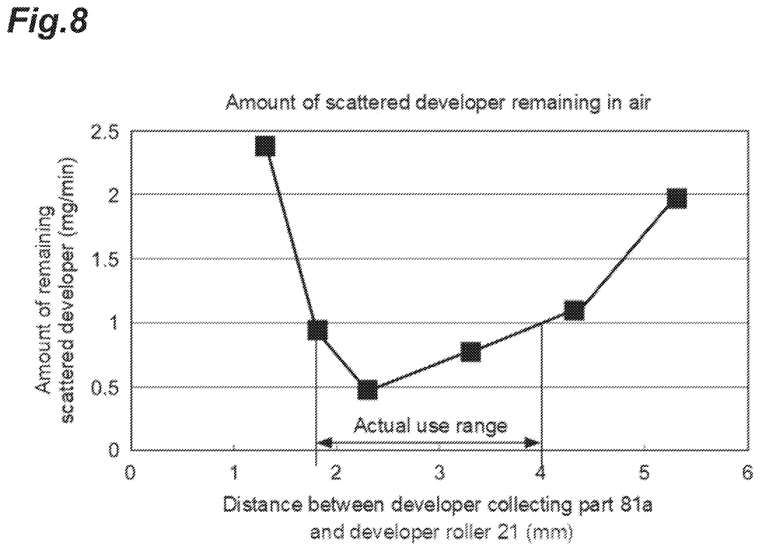

FIG. 8 is a graph showing a relation between a distance (mm) (e.g., the gap g in FIG. 6) between the developer collecting part 81a of the rectifier member 81 described above and the developer roller 21, and the amount of scattered developer remaining in the air (mg/min) (referred to hereinafter as “amount of remaining scattered developer”) after the air has moved passed the developer collecting part 81a to allow the developer roller 21 to collect the developer. The graph shows that when the distance g is too large, the collecting capability of the developer roller 21 by the magnetic force decreases to cause an increase in the amount of remaining scattered developer, while when the distance g is too small, the developer (e.g., the magnetic brush) comes in contact with the developer collecting part 81a to generate scattering of the developer in the vicinity of the air intake part 81c, thereby causing an increase in the amount of remaining scattered developer. Accordingly, an optimal value exists for the distance g. According to examples of the developing device 20, the target value of the amount of remaining scattered developer is for example 1 mg/min or less, and based on FIG. 8, the target value can be achieved by setting the distance g to a distance of approximately 1.8 mm to 4 mm.

In the example developing device 20, the surface of the developer collecting part 81a of the rectifier member 81 facing the developer roller 21 is constructed so as to form a cylindrical surface equidistant from the surface of the developer roller 21 along the circumferential direction of the developer roller 21. This allows the optimal distance g to be maintained over the entire range of the developer collecting part 81a to maximize the collection efficiency of the developer while minimizing the amount of remaining scattered developer. Depending on examples, the surface of the developer collecting part 81a of the rectifier member 81 facing the developer roller 21 is not limited to such a cylindrical surface, and in some examples, the surface may be formed as a polygonal shape or any shapes substantially equidistant from the surface of the developer roller 21 along the circumferential direction of the developer roller 21.

In the example developing device 20, while the rectifier member 81 has a uniform shape along a longitudinal direction parallel to the axial direction of the developer roller 21, in other examples, the rectifier member 81 may include a plurality of segments arranged along the longitudinal direction. In each of the segments, the distance between the developer collecting part 81a of the rectifier member 81 and the surface of the developer roller 21 may differ from the distance in another segment among the plurality of segments. Additionally, the air intake part 81c of the rectifier member 81 facing the surface of the developer roller 21 forms an opening area in each of the segments. In each of the segments, the opening area of the air intake part 81c of the rectifier member 81 facing the surface of the developer roller 21, may differ from the opening area in another segment among the plurality of segments. The air within the developing device 20 is easily drawn into the inlet port 82 from a location close to the inlet port 82 disposed in the vicinity of each of both ends in the axial direction of the developer roller 21. Accordingly, the flow rate of the air tends to locally increase at that location. The plurality of the segments of the rectifier member 81 may be formed differently to make the air intake performance variable along the longitudinal direction so as to rectify the air in such a way as to have an overall uniform flow rate along the longitudinal direction, in order to further increase the performance of collecting scattered developer.

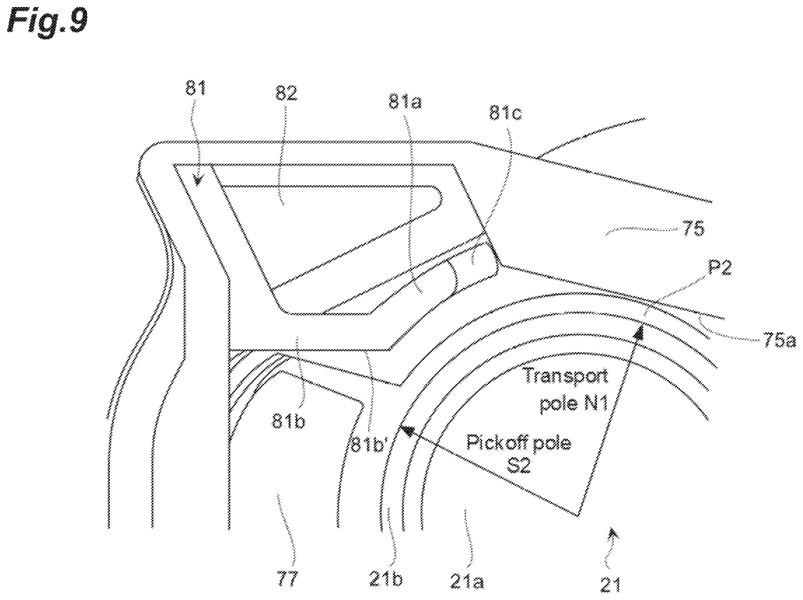

FIG. 9 is a cross-sectional view showing a positional relationship between the air intake part 81c of the rectifier member 81 and each magnetic pole of the magnetic roller 21a of the developer roller 21. The magnetic roller 21a has a rotational axis and includes, at a plurality of predetermined angle positions about the rotational axis, a plurality of magnetic poles extending along a direction parallel to the rotational axis. When the developer sleeve 21b is driven and rotated about the magnetic roller 21a, a magnetic force acts on the developer on the developer sleeve 21b when the developer sleeve passes at a position corresponding to each magnetic pole of the magnetic roller 21a, and the developer behaves according to the magnetic pole. The magnetic roller 21a may include, for example, a developing pole S1 (not illustrated) to raise the magnetic brush toward the photoconductor 40 to supply toner to the photoconductor 40, a transport pole N1 to transport the developer to the developer container 77 after the toner is supplied to the photoconductor 40, a pickoff pole (or release pole) S2 to release the developer transported into the developer container 77 from the surface of the developing sleeve 21b and return the developer to an upper space 78 above the stirring and conveying member 70, a pickup pole S3 (not illustrated) to magnetically adsorb, onto the surface of the developing sleeve 21b, the developer having a predetermined toner concentration and stirred by the stirring and conveying member 70, and a layer regulating pole N2 (not illustrated) to form the developer magnetically adsorbed onto the surface of the developing sleeve 21b into a thin layer by the layer regulating member 72 (cf. FIG. 3). The polarity (N pole, S pole) of each magnetic pole of the magnetic roller 21a or the number of the poles are not limited to the above. For example, the polarities may all be reversed from the polarities described above.

With reference to FIG. 9, the air intake part 81c of the rectifier member 81 may be disposed, for example, between the transport pole N1 and the pickoff pole S2. According to examples, the transport pole N1 may be positioned upstream of the air intake part 81c in the direction of rotation of the developing sleeve 21b in this manner, for example in the vicinity of the closest position P2 between the inner surface 75a of the upper cover 75 and the surface of the developing sleeve 21b, in order to fill the gap at the closest position P2 between the upper cover 75 and the developing sleeve 21b with the magnetic formation of developer (e.g., magnetic brush). In some examples, the height of the developer (e.g., height or thickness of the magnetic brush) on the developing sleeve 21b at a position corresponding to the transport pole N1 may be set to be substantially equal to the distance at the closet position P2 between the upper cover 75 and the developing sleeve 21b. This forms a seal that substantially prevents air from flowing from the inside of the developing device 20 to the outside thereof, so as to generate an airflow that flows from within the developer container 77 to the inlet port 82 through the air intake part 81c. In addition, as a tangential component of the magnetic force acting on the magnetic brush on the developer roller 21 increases in comparison to a normal component of the magnetic force between the transport pole N1 and the pickoff pole S2, the height of the magnetic brush formed decreases, to achieve a constant gap between the developer collecting part 81a of the rectifier member 81 and the magnetic brush on the developing sleeve 21b in a more stable manner. Consequently air, which has been guided through the rectifying part 81b of the rectifier member 81 from within the developer container 77, may be reliably guided through the gap to the air intake part 81c, and eventually to the inlet port 82.

As described above, the example developing device 20 illustrated in FIGS. 3 to 9 guides air having entered the inside of the developing device during the operation thereof by use of the rectifier member 81, to the surface of the developer roller 21, so that the scattered developer in the air is collected by the developer roller 21, and circulates the air from which the scattered developer has been collected in an air flow passage including the inlet port 82, the air guide member 80 and the outlet port 83, to prevent or inhibit an increase in the internal pressure of the developing device 20.

Accordingly, image quality is improved even under a condition of high speed printing where the developer roller rotates at a high speed, for example, by reducing or preventing an occurrence in which air within the developing device 20 including a large amount of scattered developer flows out, due to an increase in the internal pressure of the developing device 20, from a less airtight portion of the developing device 20 so as to contaminate the inside of the image forming apparatus with the developing device 20 disposed therein, and the developer scattered at that time adheres to a charger, a transfer roller or paper to cause uneven image density or image defect. In addition, the scattered developer is prevented from flowing out to the outside of the image forming apparatus and contaminating the surrounding environment.

The example developing device 20 also uses, as described above, a relatively simple constituent element as the rectifier member 81 and an existing constituent element as the developer roller 21 to collect developer in the air. Accordingly, the example developing device 20 can be achieved without any complicated part or complicated control, and without an associated increase in the parts cost or assembly cost.

In some examples, the developing device 20 may be provided with a developer supply and discharge device for supplying the developer container 77 of the developing device 20 with a new developer and discharging a deteriorated excess developer (mainly carrier e.g., carrier particles) from within the developer container 77, for example, so as to reduce or prevent an occurrence in which a developer including a non-deteriorated carrier is excessively discharged from a developer discharging part of the developer supply and discharge device due to the increase in the internal pressure of the developing device 20, such that the amount of the developer within the developing device decreases below a necessary amount, consequently causing uneven image density in the image generated by the developing device or a decrease in the image density. Accordingly, the example developing device 20 can provide a developing device and an image forming apparatus that provide good image quality for a relatively long period of time.

The example developing device 20 can also enhance an air circulation efficiency while significantly reducing the amount of scattered developer in a circulating air even when the developer roller 21 rotates at a high speed, so as to reduce or prevent an occurrence by which the developer is accumulated in a location where the developer tends to be retained hydrodynamically, such as a location where a vortex of air within the air guide member 80 occurs or a location where the volume partially expands to cause a pressure loss, resulting in the reduction of the circulation efficiency (namely, ability to lower the internal pressure) or closure of the air guide member 80 by the developer to completely lose the circulation function. In addition, as the amount of scattered developer in the circulating air is low, there is no need, for example, to provide a filter in the upper cover 75 for preventing scattering of the developer, which would reduce the circulation efficiency as a result of a pressure loss due to the filter or a clogging thereof. Additionally, as the amount of scattered developer in the circulating air is low, the cross section of the air guide member 80 in a direction orthogonal to the direction of air flow can be made smaller, to reduce the size of the whole developing device 20 including the air guide member 80.

Various occurrences described above become more notable as the number of rotations of the developer roller 21 increases. However, according to examples of the developing device 20 described herein, the amount of circulating air increases with an increase in the number of rotations of the developer roller, and the circulation of the air tends to prevent new outside air from entering, so as to prevent or inhibit the internal pressure of the developing device 20 from increasing.

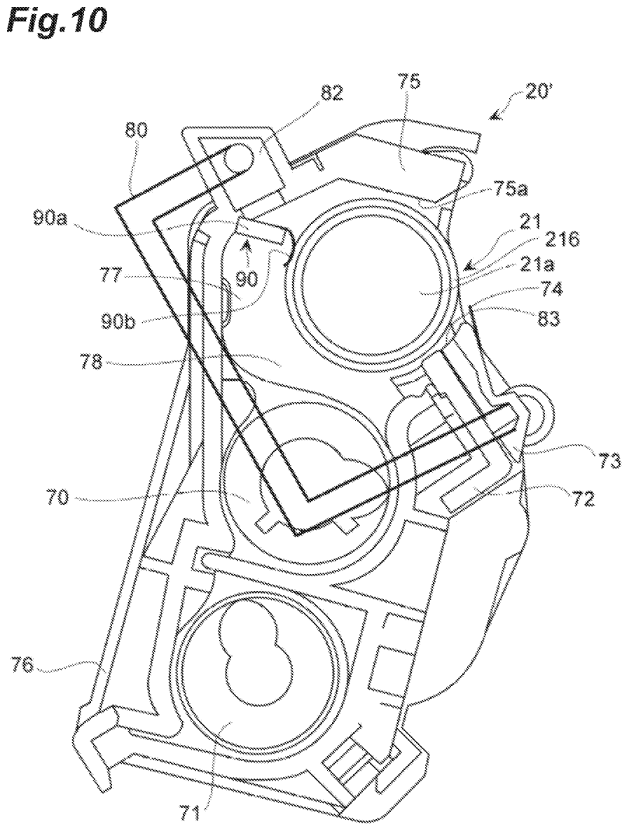

FIG. 10 is a cross-sectional view showing another example developing device 20′. The developing device 20′ is similar to the example developing device 20 illustrated in FIG. 3. However, instead of the rectifier member 81 in the developing device 20, a separator member 90 extending in the longitudinal direction, parallel to the axial direction of the developer roller 21 is disposed adjacent to the developer roller 21. The separator member 90 may include, for example, a support member 90a having a rectangular parallelepiped shape, and having one end that is fixed to the housing 76, and may further include a rectangular elastic sheet 90b having one end that is attached to the other end of the support member 90a. The other end of the elastic sheet 90b is a free end, and the free end is curved while uniformly abutting with the developer roller 21, namely, the magnetic brush on the developing sleeve 21b, over the entire range along the direction parallel to the axial direction of the developer roller 21.

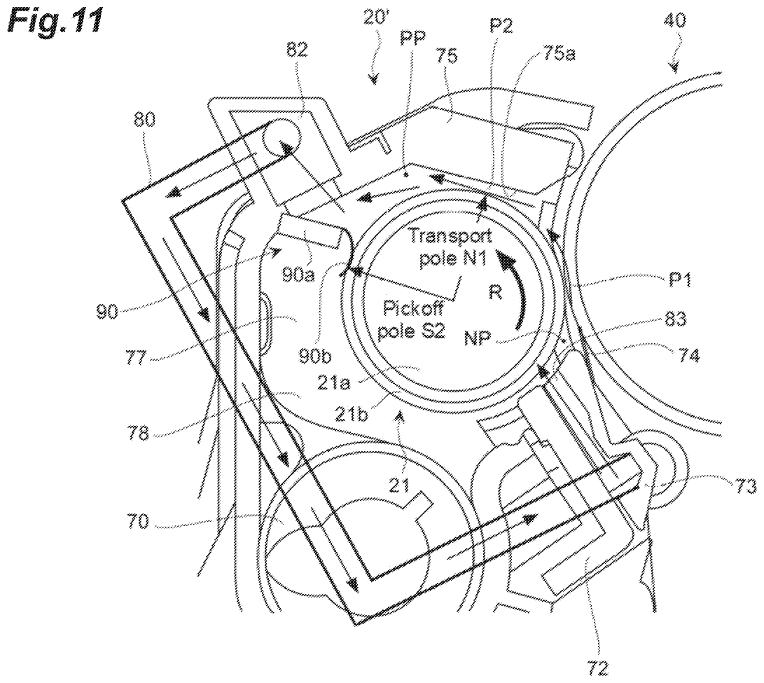

FIG. 11 is a cross-sectional view showing the example developing device 20′ together with the photoconductor 40, in which the example air flow passage is indicated by thin arrows. When the developing device 20′ operates, the developer roller 21 rotates in the direction of the arrow R shown in FIG. 11. Consequently, air outside the developing device 20′ enters the developer container 77 through the developer magnetically adsorbed onto the developer roller 21, namely, the magnetic formation of the developer (e.g., the magnetic brush). This generates a positive pressure inside the developer container 77 (namely, at the positive pressure location (or positive pressure region) PP) while generating a negative pressure upstream of and in the vicinity of the closest position P1 between the developer roller 21 and the photoconductor 40 in the direction of rotation of the developer roller 21 namely, at the negative pressure location (or negative pressure region) NP.

In this case, the inlet port 82 is positioned at the positive pressure location PP within the developing device 20′ and the outlet port 83 is positioned at the negative pressure location NP within the developing device 20′. This difference in the pressure between the inlet port 82 and the outlet port 83 generates an air flow from the inlet port 82 toward the outlet port 83 within the air guide member 80.

In the example developing device 20′, the separator member 90 including the support member 90a and the elastic sheet 90b, has one end thereof fixed to the housing 76 and the other end thereof abutting with the developer roller 21 as is described above. The separator member 90 having such a structure separates an air flow passage located above the separator member from the upper space 78 above the stirring and conveying member 70 within the developer container 77 located below the separator member. Accordingly, the air having entered the developing device 20′ does not flow to the upper space 78 above the stirring and conveying member 70 below the separator member 90 but instead flows to the inlet port 82 above the separator member, and after passing through the air guide member 80, is discharged via the outlet port 83. The air discharged through the outlet port 83 flows toward the developer roller 21 facing the outlet port 83 and the scattered developer in the air is collected by the developer on the developer roller 21. The air from which the scattered developer has been collected then passes between the developer roller 21 and the photoconductor 40, and flows from the inlet port 82 to the outlet port 83 within the developing device 20′ in the similar manner as described above. Accordingly, the air circulates in a route in the order of the positive pressure location PP, the inlet port 82, the air guide member 80, the outlet port 83, the negative pressure location NP, and the positive pressure location PP, to prevent or inhibit an increase in the atmospheric pressure within the developing device 20′.

In the case of the developing device 20′ similarly to the developing device 20, the transport pole N1 may be positioned upstream of the inlet port 82 in the direction of rotation of the developing sleeve 21b, for example in the vicinity of the closest position P2 between the inner surface 75a of the upper cover 75 and the surface of the developing sleeve 21b, to fill the gap at the closest position P2 between the inner surface 75a of the upper cover 75 and the surface of the developing sleeve 21b with the magnetic formation of developer (e.g., magnetic brush). In some examples, the height of the developer on the developing sleeve 21b at the position corresponding to the transport pole N1 may be set to be substantially equal to the distance at the closet position P2 between the upper cover 75 and the developing sleeve 21b. This minimizes the air flowing from the outside of the developing device 20′ to the inside, and at the same time to form a seal that substantially prevents air flowing from the inside of the developing device 20′ to the outside thereof, to more reliably guide the air from within the developer container 77 to the inlet port 82.

The separator member 90 may be disposed between the transport pole N1 and the pickoff pole S2. As described above, as the tangential component of the magnetic force acting on the magnetic brush on the developer roller 21 increases in comparison to the normal component of the magnetic force between those magnetic poles, the height of the magnetic brush formed decreases, in order to achieve a constant gap between the magnetic brush on the developer sleeve 21b located between the transport pole N1 and the pickoff pole S2 and the inner surface 75a of the upper cover 75 located above the magnetic brush, in a more stable manner. Consequently the air, which has entered the developer container 77, may be efficiently guided to the inlet port 82 through the gap.

The elastic sheet 90b of the separator member 90 may be formed of a material such as urethane. The elastic sheet 90b may have a thickness of approximately 0.3 mm or less according to some examples, or of approximately 0.2 mm or less according to other examples.

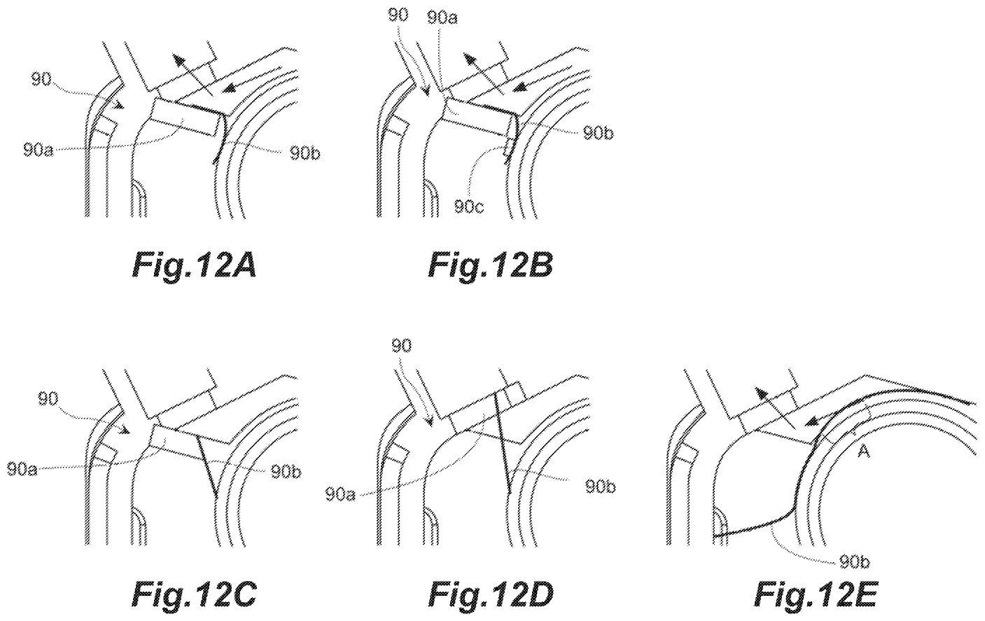

FIG. 12A to 12E are cross-sectional views showing other examples of the separator member 90 that may be used in the developing device 20′. In the examples shown in FIGS. 10 and 11, the elastic sheet 90b of the separator member 90 is formed of a single material as is shown in FIG. 12A. However, with reference to FIG. 12B, the separator member 90 may include the elastic sheet 90b and a magnetic plate (or a magnetic film) 90c bonded to a free end of the elastic sheet. In this case, as the magnetic plate (or a magnetic film) 90c is magnetically adsorbed onto the developer roller 21 (e.g., the magnetic brush on the developer sleeve 21b) through the elastic sheet 90b, the air flow passage can more reliably be separated from the upper space 78 (cf. FIG. 11) above the stirring and conveying member 70. The elastic sheet 90b of the separator member 90 having the structure shown in FIG. 12B may also be formed of a material such as urethane, and may have a thickness of approximately 0.2 mm or less in some examples, or of approximately 0.1 mm or less in other examples. The magnetic plate 90c may be formed, for example, of a magnetic metal such as iron, cobalt and nickel (e.g., iron or nickel in some examples), and for the magnetic film 90c, a film for suppressing noise used in a cell phone and the like may be used. The magnetic plate (or the magnetic film) 90c may have a width in a direction orthogonal to the axial direction of the developer roller of, for example, approximately 10 mm or less in some examples, or of approximately 3 to 5 mm in other examples. The angle position of the magnetic plate about the rotational axis of the developer roller 21 may, for example, be between the pickoff pole and the transport pole, and may be in the range of 10 to 30 degrees from the pickoff pole toward the transport pole. The surface of the magnetic plate 90c on the opposite side of the elastic sheet 90b may be provided with a coating or attached with a resin sheet and the like so as to prevent adhesion of the developer and to prevent rust.

Examples shown in FIGS. 10, 11, 12A and 12B show that the elastic sheet 90b of the separator member 90 is curved by abutting with the developer roller 21. However, the elastic sheet 90b is not limited to such a shape. With reference to FIGS. 12C and 12D, the elastic sheet 90b may abut with the surface of the developer roller 21 without curving the distal end of the elastic sheet. In this case, the elastic sheet 90b may be formed of a material such as urethane, and may have a thickness of approximately 0.3 mm or less in some examples, or of approximately 0.2 mm or less in other examples.

In some examples, the separator member 90 is not composed of the support member 90a and the elastic sheet 90b as in the examples shown in FIGS. 10, 11 and 12A to 12D. For example, a structure corresponding to the support member 90a may be integrally formed with the housing 76, and the separator member 90 may be composed of the elastic sheet 90b exclusively, and may be attached to the structure.

Additionally, the separator member 90 may be constructed by directly attaching the elastic sheet 90b to the housing or the like of the developing device 20′ without forming the structure corresponding to the support member 90a in the housing 76. In this case, for example, one end of the elastic sheet 90b may be attached to one end (in the vicinity of the right-side end in FIG. 12A) and to an inner wall of the upper cover 75 of the developing device 20′. As is shown in FIG. 12E, the elastic sheet 90b includes, in a direction opposite to the rotational direction of the developer roller 21 from the above attaching portion, a portion that is free from the surface of the developer roller 21, a portion that contacts the developer roller 21 and a portion that is free from the developer roller 21 and that contacts the inner wall of the developer container 77. An opening is formed in a region A which is part of the portion that is free from the surface of the developer roller 21, and the air enters the developer container 77 through the opening. In the developing device 20′ having such a structure, a space above the elastic sheet 90a is separated from a space below the elastic sheet 90a, e.g., the upper space 78 above the stirring and conveying member 70 (cf. FIG. 11), and the air having passed through the space above the elastic sheet 90a after passing the opening, enters the inlet port 82. As such, the developing device 20′ shown in FIG. 12E exhibits an action and an effect substantially similar to those of the structures shown in FIGS. 10 and 11. In this case, the elastic sheet 90b may be formed of a material such as urethane, and may have a thickness of approximately 0.3 mm or less in some examples, or of approximately 0.2 mm or less in other examples.

As described above, the developing devices 20′ according to the examples described with reference to FIGS. 10 to 12E includes the separator member 90 that separates, from the upper space 78 above the stirring and conveying member 70, the air flow passage from the positive pressure location PP to the inlet port 82, and eventually the air flow passage including the positive pressure location PP, the inlet port 82, the outlet port 83 and the negative pressure location NP. In the example developing device 20′, the amount of scattered developer in the air circulating in the above air flow passage is negligible compared to the amount of scattered developer in the air within the upper space 78 above the stirring and conveying member 70 separated by the separator member 90 from the air flow passage. Accordingly, allowing the air to circulate in the air flow passage including the inlet port 82, air guide member 80 and the outlet port 83 and allowing the developer roller 21 to collect the scattered developer in the air can prevent or inhibit an increase in the internal pressure of the developing device 20′ without causing accumulation of the developer within the air flow passage.

Consequently, the example developing device 20′, even under a condition of high speed printing where the developer roller rotates at a high speed, for example, prevents or reduces an occurrence in which air within the upper space 78 above the stirring and conveying member 70 including a large amount of scattered developer flows out, due to an increase in the internal pressure of the developing device 20′, from a less airtight portion of the developing device 20′ to contaminate the inside of the image forming apparatus with the developing device 20′ disposed therein, and the developer scattered at that time adheres to paper to cause uneven image density or image defect. In addition, the scattered developer is prevented from flowing out to the outside of the image forming apparatus and contaminating the surrounding environment.

The example developing device 20′ can also prevent the scattered developer in the upper space 78 above the stirring and conveying member 70 from flowing to the outside by use of a simple constituent element as the separator member 90 as described above. Accordingly, the example developing device 20′ can be achieved without any complicated parts or complicated controls, and without an associated increase in the parts cost or assembly cost.

In addition, the example developing device that is provided with a developer supply and discharge mechanism for supplying the developer container 77 of the developing device 20′ with a new developer and discharging a deteriorated excess developer (mainly carrier particles) from within the developer container 77, for example, prevents or reduces an occurrence in which a developer including a non-deteriorated carrier is excessively discharged from a developer discharging part of the developer supply and discharge mechanism due to the increase in the internal pressure of the developing device 20′ and the amount of the developer within the developing device decreases below a necessary amount, consequently causing uneven image density in the image generated by the developing device or decrease in the image density. Accordingly, the example developing device 20′ can provide a developing device and an image forming apparatus that provide good image quality for a relatively long period of time.

The example developing device 20′ can also enhance an air circulation efficiency while significantly reducing the amount of scattered developer in a circulating air even when the developer roller 21 rotates at a high speed, so as to reduce or prevent an occurrence by which the developer is accumulated in a location where the developer tends to be retained hydrodynamically, such as a location where a vortex of air within the air guide member 80 occurs or a location where the volume partially expands to cause a pressure loss, resulting in the reduction of the circulation efficiency (namely, ability to lower the internal pressure) or closure of the air guide member 80 by the developer to completely lose the circulation function. In addition, as the amount of scattered developer in the circulating air is low, there is no need, for example, to provide a filter in the outlet port 83 for preventing scattering of the developer, which may reduce the circulation efficiency as a result of a pressure loss due to the filter or a clogging thereof. Additionally, as it is possible to set the amount of scattered developer in the circulating air to be low, and also keep the air circulation efficiency high, the cross section of the air guide member 80 in the direction orthogonal to the direction of air flow can be made smaller, to reduce the size of the whole developing device 20′ including the air guide member 80.

Various occurrences described above become more notable as the number of rotations of the developer roller 21 increases. However, according to examples the developing device 20′ described herein, the amount of circulating air increases with an increase in the number of rotations of the developer roller, and the circulation of the air tends to prevent new outside air from entering, so as to prevent or inhibit the internal pressure of the developing device 20′ from increasing.

It is noted that, while the example of disposing the rectifier member 81 and the example of disposing the separator member 90 have been described as separate examples, it is possible to provide, for example, both the rectifier member 81 and the separator member 90 within the same developing device 20. In such a case, the separator member 90, for example, the elastic sheet 90b, is uniformly abutted with the developer roller along the direction parallel to the axial direction of the developer roller as described above, but can be formed into various shapes such as a toothed-comb shape in which a projecting portion abutting with the developer roller and a recessed portion not contacting the developer roller are alternately formed along the longitudinal direction parallel to the axial direction of the developer roller, or a rectangular shape in which a recessed portion not contacting the developer roller is formed exclusively at both ends along the longitudinal direction. In addition, while an image forming apparatus for forming color images has been described herein, the developing device of the present disclosure can also be applied, without being limited to the above-described, to image forming apparatuses and the like forming monochrome images.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. A developing device comprising:
a developer roller that is rotatable about an axis defining an axial direction, to carry a developer to a development region;
a rectifier member extending in a direction parallel to the axial direction of the developer roller, the rectifier member comprising:
a developer collecting part spaced apart by a minimum distance from a surface of the developer roller; and
a rectifying part to guide air from within the developing device via the developer collecting part toward an upstream side of the development region, in a rotational direction of the developer roller.

2. The developing device according to claim 1, wherein a minimum distance between a surface of the rectifying part facing the developer roller, and the surface of the developer roller gradually decreases from a distal location to a proximal location, relative to the developer collecting part, of the surface of the rectifying part facing the developer roller.

3. The developing device according to claim 1, wherein a surface of the developer collecting part facing the developer roller has a substantially uniform distance from the surface of the developer roller along a peripheral direction of the developer roller.

4. The developing device according to claim 3, wherein the uniform distance is approximately 1.8 mm to 4 mm.

5. The developing device according to claim 1, wherein the rectifier member comprises an air intake part disposed upstream of the developer collecting part in the rotational direction of the developer roller.

6. The developing device according to claim 5, wherein the air intake part is disposed downstream of a closest position between an upper cover of the developing device and the developer roller, in the rotational direction of the developer roller.

7. The developing device according to claim 5,
wherein the developer roller includes:
a transport pole to transport a developer having passed downstream beyond a closest position between the developer roller and a photoconductor, in the rotational direction of the developer roller; and
a pickoff pole to release the developer transported by the transport pole from the surface of the developer roller, and
wherein the air intake part of the rectifier member is located substantially midway between the transport pole and the pickoff pole.

8. The developing device according to claim 7, comprising
a developer container having an inner surface located adjacent the developer roller and upstream of the rectifier member in the rotational direction of the developer roller,
wherein the developer roller is closest to the inner surface of the developer container at a transport pole position corresponding to the transport pole of the developer roller, and
wherein a minimum distance between the developer roller and the inner surface of the developer container taken at the transport pole position is substantially equal to a height of the developer to be formed on the developer roller at the transport pole position of the developer roller.

9. The developing device according to claim 5,
wherein the rectifier member includes a plurality of segments arranged along a direction parallel to the axial direction of the developer roller,
wherein in each of the segments, the developer collecting part of the rectifier member is spaced apart from the surface of the developer roller by a distance, and
wherein at least two segments among the plurality of segments form different distances from the developer collecting part to the surface of the developer roller.

10. The developing device according to claim 5,
wherein the rectifier member includes a plurality of segments arranged along a direction parallel to the axial direction of the developer roller,
wherein in each of the segments, the air intake part of the rectifier member facing the surface of the developer roller forms an opening area, and
wherein at least two segments among the plurality of segments have different opening areas.

11. The developing device according to claim 8,
wherein an inlet port is disposed in a positive pressure location adjacent the developer roller,
wherein an outlet port is disposed in a negative pressure location adjacent the developer roller,
wherein an air guide member fluidically connects the inlet port and the outlet port, and
wherein the air intake part of the rectifier member fluidically communicates with the inlet port.

12. The developing device according to claim 11,
wherein the development region is located at a closest position between the developer roller and the photoconductor in the rotational direction of the developer roller,
wherein the inlet port is located within the developer container, and
wherein the outlet port is located upstream of and in the vicinity of the closest position.

13. The developing device according to claim 11, wherein the air guide member includes a layer regulating member and a layer regulating member cover that extend longitudinally so as to form an end portion facing the developer roller, and wherein the outlet port is formed at the end portion facing the developer roller.

14. A developing device comprising:
a developer roller located between a stirring and conveying member and an upper cover, wherein an upper space is formed above the stirring and conveying member, and wherein a positive pressure region is formed downstream of and in the vicinity of a closest position between the upper cover and the developer roller; and
a separator member to fluidically separate the positive pressure region from the upper space above the stirring and conveying member.

15. An image forming apparatus comprising:
a photoconductor to form an electrostatic latent image; and
a developing device to develop the electrostatic latent image, wherein the developing device comprises:
a developer roller having a surface to carry a developer, wherein the developer roller is rotatable to carry the developer to a development region that faces the photoconductor; and
a rectifier member located adjacent the developer roller, wherein the rectifier member comprises:
a developer collecting part that is spaced apart from the surface of the developer roller to draw air from within the developing device; and
a rectifying part extending from the developer collecting part, to guide the air toward an upstream side of the development region of the developer roller, in a rotational direction of the developer roller.
